(19) United States
(12) Patent Application Publication
(10) Pub. No.: US 2011/0047868 A1
(43) Pub. Date: Mar. 3, 2011

(54) MINI-GREENHOUSE AND PLANT PROTECTOR

(76) Inventors: Shanthala Mudegowda, Woodinville, WA (US); Robert Lee Rawls, Woodinville, WA (US)

(21) Appl. No.: 12/547,254

(22) Filed: Aug. 25, 2009

(51) Int. Cl. A01G 9/16; F24F 7/00

(52) U.S. Cl. 47/17; 454/254

(57) ABSTRACT

A one piece, nestable, portable mini-greenhouse and plant protector for use in a substrate, such as soil, to protect plants and seedlings from extreme weather elements, bugs and pests. The mini-greenhouse has a light-transmitting shell that forms a protective chamber and integrated legs that act to anchor as well as support the shell. The legs can be fully or partially inserted in the soil providing options for a closed or ventilated protective chamber. The unit has concave channels that facilitate watering without disturbing the apparatus. It has unique light filtering and dispersing properties to aid creating a nurturing and growing environment.

### FIELD OF INVENTION

The apparatus of this patent relates to plant protection. The invention is directed towards the creation of an environment that is optimal for young plants, seedlings, and plants left to be over-wintered.

### BACKGROUND

There are many prior art devices intended to provide shelter for young plants, thereby extending the growing season. Plants in their early growing stages may need protection from weather elements such as frost, snow, hail, heavy rain, wind, and temperature fluctuations. Plants also need to be protected from pests such as slugs, bugs, squirrels, rabbits, and deer. Many different approaches have been tried to achieve this: Greenhouses, Cold-frames, cloches, bell jars, and cones. Greenhouses are bulky, space consuming, high-maintenance, and expensive. Cold frames are stiff and bulky. Cloth cloches wear out and are not effective light transmitters. Bell jar type devices can be heavy, bulky, and/or ineffective regulators for air, water, and light and are generally only effective for one plant at a time.

Mini greenhouses have been designed, with limited success. The prior art mini greenhouse devices are deficient. In most cases they are difficult or impossible to store in a small space. They also require secondary components or structures to aid in ventilation; openings that need closing or secondary covers that need removing. These additional parts and covers make these devices costly and cumbersome.

The prior art mini greenhouse devices are also deficient in that they do not generally control the intensity, frequency and quality of light within the enclosure. There is, therefore, a need for a mini greenhouse that is inexpensive, compact, and easily stored with features to readily regulate ventilation and provide an optimal light quality.

### BRIEF DESCRIPTION OF THE DRAWINGS

FIG. 1. Is an isometric view showing various aspects of the preferred embodiment;

FIG. 2. Is a side view of the preferred embodiment;

FIG. 3. Is a frontal view of the preferred embodiment;

FIG. 4. Is an illustration showing the anchor legs partially inserted into soil;

FIG. 5. Is an illustration showing the anchor legs fully inserted into soil;

FIG. 6. Is an isometric bottom view of the preferred embodiment;

FIG. 7. Illustrates the stacking feature of the preferred embodiment;

FIG. 8. Illustrates an alternate embodiment of the invention;

FIG. 9. Illustrates the stacking feature of the alternate embodiment.

### DETAILED DESCRIPTION OF THE PREFERRED EMBODIMENT

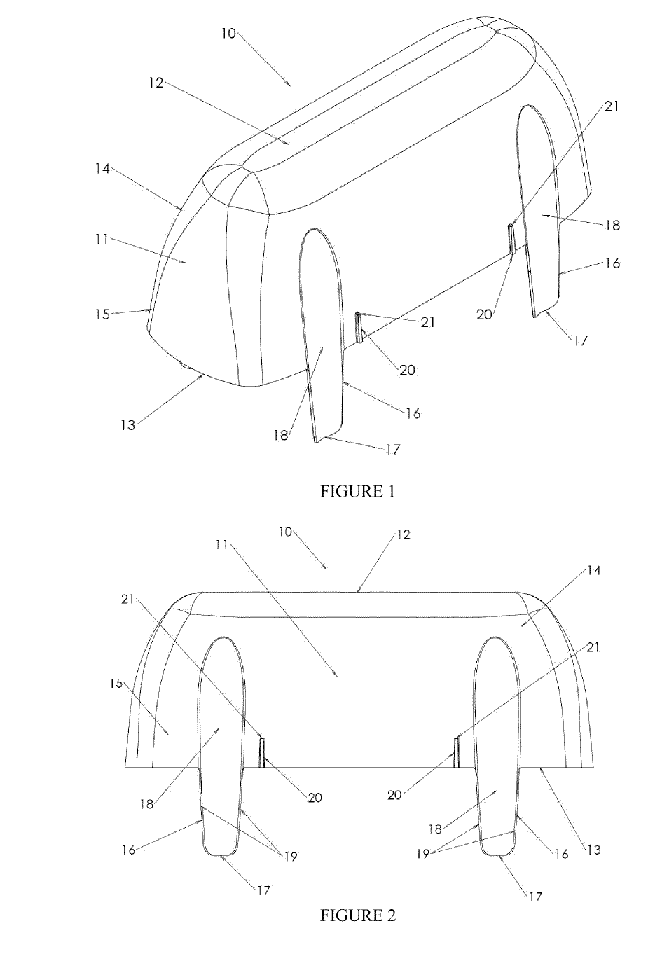

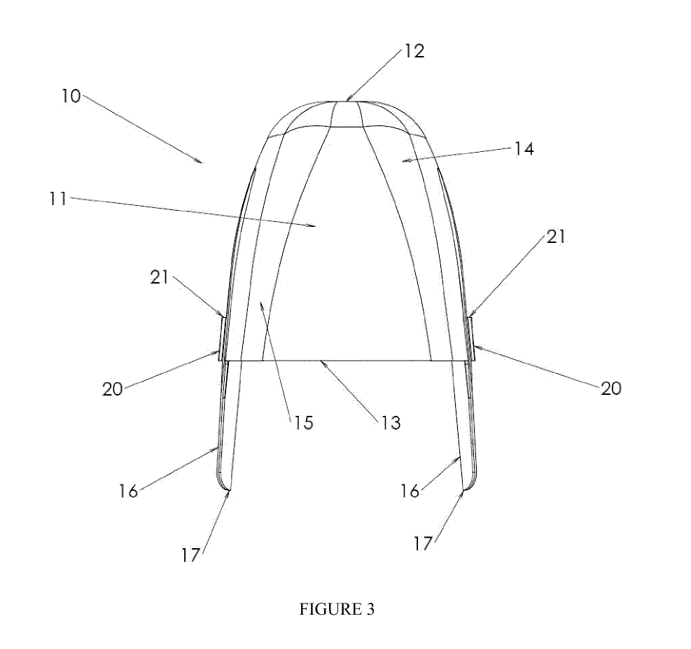

FIGS. 1-7 show one embodiment of the apparatus 10. This embodiment is created as a single piece injection molded unit. However, it would also be possible to make the apparatus from a combination of parts. The apparatus 10 is formed from a substantially clear, un-tinted plastic such as a polycarbonate, but it could be made from any optically suitable (as desired) light-transmitting, i.e. non-opaque material. An alternative embodiment of this invention is made from colored or tinted material so as to filter specific light frequencies in the shell 11. Such light filtering may benefit certain plants, taking into account the seasonal state and the growth stage of the plant. The apparatus 10 is made of a material that resists bending. While the material may be subject to some flexing, the material of the apparatus 10, when used as intended, is stiff or hard enough to substantially retain its original formed shape at all times without requiring any other supporting structure.

The shell 11 has a closed top 12 and an open bottom 13, forming a protective volume or chamber that is open at the bottom. Employing a process such as injection molding allows for varying surface treatments throughout the mold tool that form the finished part. By polishing the tool surface in an area it is possible to create an area of the shell 11 that will only minimally distort the light that passes through that area, thus, making the area transparent. By texturing an area of the tool surface it is possible to create an area of the shell 11 that will diffuse the light passing through that area, thus, making that area translucent. Diffusing the light through a translucent shell is advantageous in that it can prevent light/heat concentrations within the shell 11, therefore, providing a better growing environment for young plants.

The shell 11 has an upper portion 14 and a lower portion 15. In the apparatus 10, the inner surface of the upper portion 14 is textured so it may diffuse light as it passes through the upper shell portion 14 thereby rendering the upper shell portion 14 translucent. The lower portion 15 is polished so that light passes through the lower shell portion 15 with minimal optical distortion, thus creating a transparent lower shell portion 15. This permits viewing of the plants through the lower portion 15 without having to lift the device and disrupt the plants. Similarly, the outer surfaces of both the upper portion 14 and the lower portion 15 may be polished or textured.

The apparatus 10 is shown with four legs 16, two on each side; other embodiments may or may not have four legs. In the apparatus 10 the leg 16 is shown integrated with the shell 11, but it is also possible to design the leg as a separate part that can couple with the shell. The sides of the leg 16 are shown tapered 19. Each leg 16 has a first/upper end portion at the bottom end of the shell 13 and a second/lower end portion 17 distal from the first end portion for insertion into a substrate 22. Each leg 16 also has a third/intermediate portion that is between the upper and lower end portions. The cross section of the leg 16 at the upper end is greater than the cross section of the leg 16 at the lower end and the width of the cross section in the intermediate portion of the leg decreases in width as the intermediate cross section moves from the upper end of leg 16 to the lower end of leg 16. Each leg 16 may serve multiple functions including: to anchor the shell 11 to a substrate 22 such as garden soil, to support the shell 11 above the substrate 22, and to channel water into the substrate 22.

The size of the leg 16 allows it to serve as an effective anchor, thus helping to prevent the unit from being blown out of position or disturbed by small pests. The bottom of the leg 17 is shaped to facilitate penetration into the substrate. In contrast, the sides of the leg 16 are tapered 19 to resist penetration into the substrate 22. Pushing the leg 16 into the substrate not only requires overcoming the substrate 22 resistance met by the tip of the leg 17, it also requires creating an ever widening hole in the substrate 22 to accommodate the larger cross section. The force required to push the legs 16 into the substrate increases as the legs 16 are pushed further into the substrate 22.

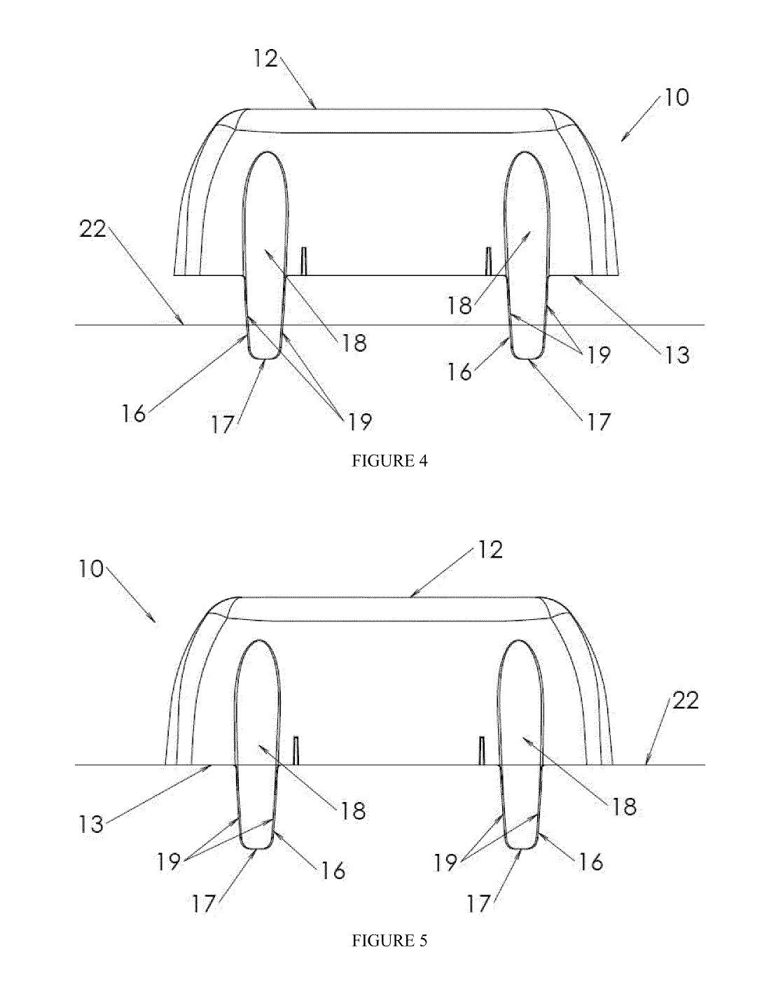

Except in extremely loose substrate, the bottom of the shell 13 can be set above the substrate 22, where it will stay, as shown in FIG. 4. The gap between the substrate 22 and the bottom of the shell 13 may be selectively adjusted/configured by inserting the legs 16 into the substrate 22 either fully, with the shell resting directly on top of the substrate 22, or by penetrating the substrate with the leg 16 only partially to selectively varying depth. Selectively adjusting the height of the shell 11 above the substrate 22 in this way sets and controls the open space (gap) between the substrate 22 and the open bottom of the shell 13, allowing for communication between the open air and the interior volume of the shell, for ventilation or access for pollinators. Thus the legs 16 play the role of a stand to support the shell 11 above the substrate. The shape and size of the legs 16 are designed to allow the shell to be held stably at different leg insertion depths. Alternatively, ventilation and access may be closed-off by pushing the legs 16 fully into the substrate 22 until the open bottom of the shell 13 touches the substrate 22 as shown in FIG. 5. An alternative embodiment, for use in hotter climates, could include ventilation holes in the shell 11 so that ventilation would never be completely cut off to the plants.

The leg 16 has a concave outer surface or channel 18. The shape of the leg 16 and the material rigidity help to provide the structural strength necessary to resist bending and breaking the leg 16 as it is pushed in and out of the substrate 22. The channel 18 helps to provide a path for directing water, collected on the shell 11 surface from rain or irrigation, from the shell 11 surface to the substrate through the concave channel 18.

The leg 16 may be designed to serve these three functions. It should be understood, however, that the legs of certain embodiments need not serve every one of these functions.

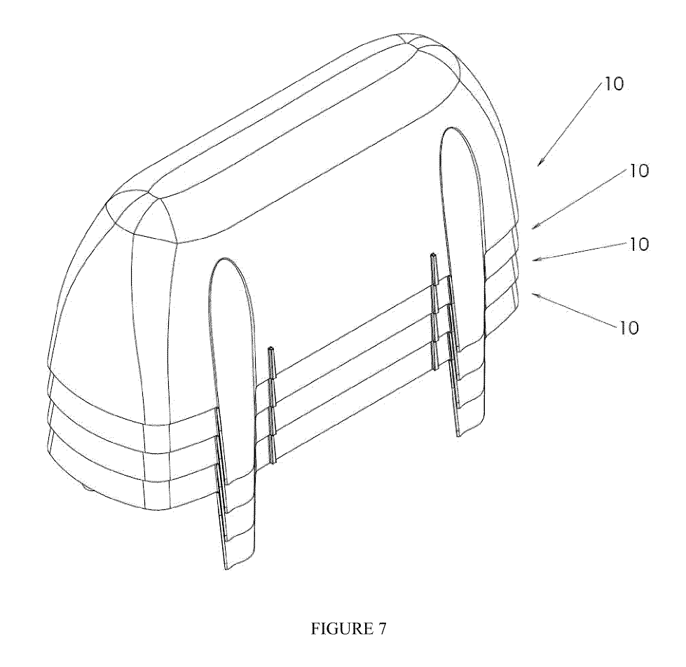

Another salient feature of the apparatus 10 is its design for nestablility and compact storage. The sides of shell 11 of apparatus 10 are projected inwards, meaning that all sides of the shell 11, with only minor deviations, move towards the center as they extend from the open bottom of the shell 13. To qualify as a minor deviation, the deviation must be small enough that it does not prevent efficient nesting as described below. In addition, the inner surface of apparatus 11 is uniformly offset from the outer surface so the interior and exterior surface shapes are similar. Some deviation from this uniform offset is permissible to allow for imperfections, cosmetic features, ribbing, etc. Any imperfectly offset surface is considered substantially uniformly offset when the deviations are not large enough to prevent efficient nesting as described below. The inward projection of the sides and the uniform shape of the inner and outer surfaces produce a part that will nest, i.e. two like embodiments of apparatus 10 will nest compactly. Most of the shell 11 of a first unit will insert into the chamber formed by the shell 11 of a second like unit before the outer surface of shell 11 of the first unit comes into contact with the inner surface of the shell 11 of the second unit. FIG. 7 illustrates a number of like units so nested or stacked. Thus, storage of unused units takes up only a minimal space. Stops 20 may be integrated with shell 11 to prevent the inner surface of one shell 11 and the outer surface of the shell 11 below from jamming together when tightly nested. The upper surface 21 of stops 20 is a rest for the bottom of shell 11 when the units are stacked as shown in FIG. 7.

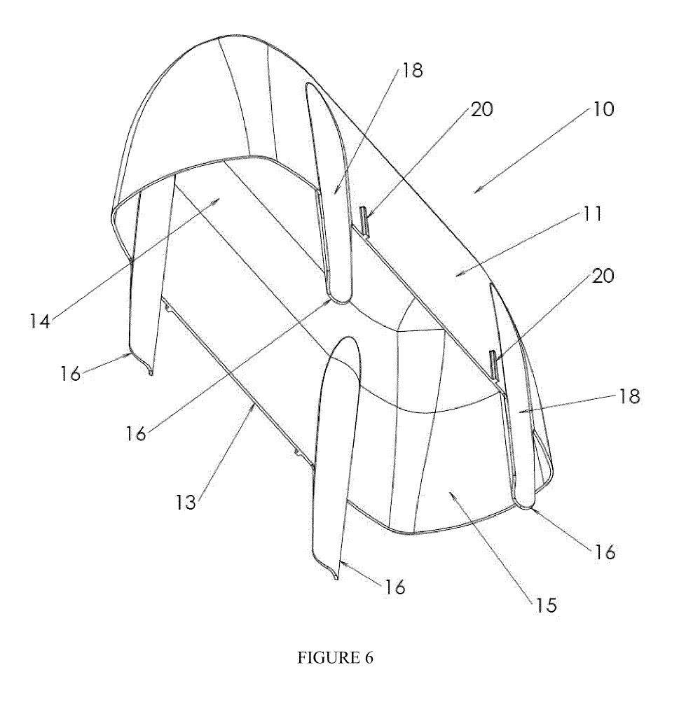

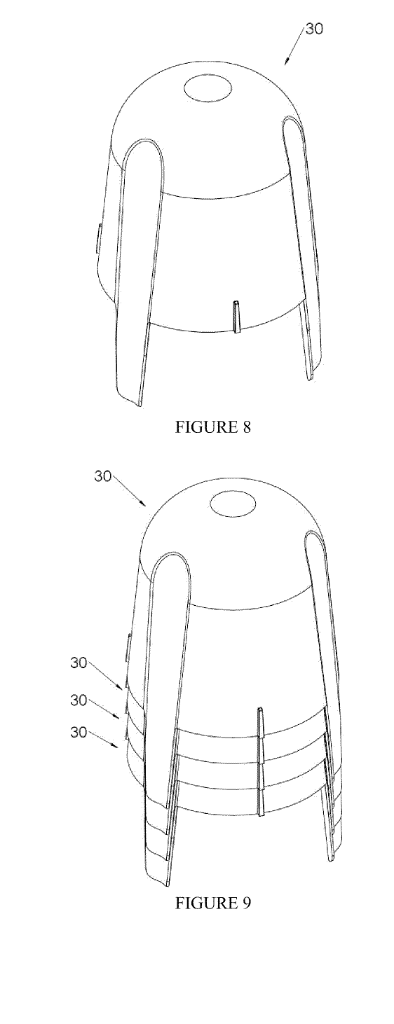

As shown in FIG. 6, the sides of shell 11 of apparatus 10 are elongated in one horizontal direction so that the open bottom 13 forms a rectangularized oval. FIGS. 8 and 9 show an alternate embodiment 30 with all of the same features described above except that the sides of the shell are not elongated horizontally and are generally co-radial, the result is an open bottom that is generally circular in shape and this embodiment has only 3 legs. It will be obvious to the reader that the invention described above will lend itself to many shapes and sizes and should not be considered limited to any particular shape, size or number of legs.

What is claimed is:

1. A portable greenhouse for positioning directly on a substrate, comprising:
a hard shell comprised of a light-transmitting material having sides, each side having a bottom end, the sides projecting upwardly and inwardly as they rise from the bottom ends to define a substantially enclosed interior volume with the bottom ends defining a generally open bottom of the interior volume, the sides each having an inner surface and an outer surface, the outer surface being substantially uniformly offset from the inner surface; and
a plurality of legs, each leg supportably coupled to one of the sides and extending downwardly beyond the bottom end of the side and configured to selectively rest atop the substrate or penetrate the substrate to a variable depth to stably support the shell with the open bottom of the shell at selectively variable heights at or above the substrate to provide a selectively variable open space between the substrate and the open bottom of the shell which is in communication with the interior volume, each leg having an upper first end portion adjacent to the bottom end of the side to which coupled, a lower second end portion distal from the first end portion and engageable with the substrate, and an intermediate third portion extending between the first and second end portions, the first end portion having a first leg cross section with a first width, the second end portion having a second leg cross section with a second width, the first width being greater than the second width, and the width of the intermediate third portion cross section generally downwardly decreasing in width from the first width adjacent to the first end portion to the second width adjacent to the second end portion.

2. A portable greenhouse of claim 1 wherein each leg has a concave outwardly facing surface.

3. A portable greenhouse of claim 1 wherein the plurality of legs includes four legs, and the sides include two generally opposing first and second sides with two of the legs coupled to the first side and two of the legs coupled to the second side.

4. A portable greenhouse of claim 1 wherein the shell is comprised of substantially co-radial sides, and the open bottom of shell is substantially circular.

5. A portable greenhouse for positioning directly on a substrate, comprising:
a hard shell comprised of a light-transmitting material having sides, each side having a bottom end, the sides projecting upwardly from the bottom ends to define a substantially enclosed interior volume with the bottom ends defining a generally open bottom of the interior volume; and
a leg supportably coupled to one of the sides and extending downwardly beyond the bottom end of the side and configured to selectively rest atop the substrate or penetrate the substrate to a variable depth to stably support the shell with the open bottom of the shell at selectively variable heights at or above the substrate to provide a selectively variable open space between the substrate and the open bottom of the shell which is in communication with the interior volume, the leg having a concave outwardly facing surface.

6. A portable greenhouse of claim 5 further comprising sides of the shell that are projected inwards as they rise from the generally open bottom of the shell, and the sides each having an inner surface and an outer surface, the outer surface being substantially uniformly offset from the inner surface.

7. A portable greenhouse of claim 5 wherein the leg has an upper first end portion adjacent to the bottom end of the side to which coupled, a lower second end portion distal from the first end portion and engageable with the substrate, and an intermediate third portion extending between the first and second end portions, the first end portion having a first leg cross section with a first width, the second end portion having a second leg cross section with a second width, the first width being greater than the second width, and the width of the intermediate third portion cross section generally downwardly decreasing in width from the first width adjacent to the first end portion to the second width adjacent to the second end portion;

8. A portable greenhouse of claim 5 comprising a plurality of legs.

9. A portable greenhouse of claim 5 wherein the material of the shell includes both translucent and substantially transparent portions.

10. A portable greenhouse of claim 5 wherein the material of the shell is comprised of material that is colored or tinted.

11. A portable greenhouse for positioning directly on a substrate, comprising:
a hard shell comprised of a light-transmitting material having sides, each side having a bottom end, the sides projecting upwardly and inwardly as they rise from the bottom ends to define a substantially enclosed interior volume with the bottom ends defining a generally open bottom of the interior volume, the sides each having an inner surface and an outer surface, the outer surface being substantially uniformly offset from the inner surface; and
a leg formed as one with and rigidly coupled to one of the sides and extending downwardly beyond the bottom end of the side and configured to selectively rest atop the substrate or penetrate the substrate to a variable depth to stably support the shell with the open bottom of the shell at selectively variable heights at or above the substrate to provide a selectively variable open space between the substrate and the open bottom of the shell which is in communication with the interior volume.

12. A portable greenhouse of claim 11 wherein the leg has a concave outwardly facing surface.

13. A portable greenhouse of claim 11 comprising a plurality of legs.

14. A portable greenhouse of claim 11 wherein the material of the shell includes both translucent and substantially transparent portions.

15. A portable greenhouse for positioning directly on a substrate, comprising:
a shell comprised of a light-transmitting material; and
the shell having sides, each side having a bottom end, the sides projecting upwardly as they rise from the bottom ends to define a substantially enclosed interior volume with the bottom ends defining a generally open bottom of the interior volume; and
a leg supportably coupled to one of the sides and extending downwardly beyond the bottom end of the side and configured to selectively rest atop the substrate or penetrate the substrate to a variable depth to stably support the shell with the open bottom of the shell at selectively variable heights at or above the substrate to provide a selectively variable open space between the substrate and the open bottom of the shell which is in communication with the interior volume.

16. A portable greenhouse of claim 15 wherein the shell is comprised of a light-transmitting material that includes both translucent and substantially transparent portions.

17. A portable greenhouse of claim 16 wherein the lower portion of the shell is substantially transparent and the upper portion is translucent.

18. A portable greenhouse of claim 15 wherein the material of the shell is colored or tinted.

19. A portable greenhouse for positioning directly on a substrate, comprising:
a hard shell comprised of a light-transmitting material having sides, each side having a bottom end, the sides projecting upwardly as they rise from the bottom ends to define a substantially enclosed interior volume with the bottom ends defining a generally open bottom of the interior volume; and
the material of the shell is translucent in the upper portion of the shell and substantially transparent in the lower portion of the shell.

20. A portable greenhouse of claim 19 wherein the shell has a leg coupled to the side of the shell and extending downwardly beyond the bottom end of the side and configured to selectively rest atop the substrate or penetrate the substrate to a variable depth to stably support the shell with the open bottom of the shell at selectively variable heights at or above the substrate to provide a selectively variable open space between the substrate and the open bottom of the shell which is in communication with the interior volume.

21. A portable greenhouse of claim 20 wherein the leg has an upper first end portion adjacent to the bottom end of the side to which coupled, a lower second end portion distal from the first end portion and engageable with the substrate, and an intermediate third portion extending between the first and second end portions, the first end portion having a first leg cross section with a first width, the second end portion having a second leg cross section with a second width, the first width being greater than the second width, and the width of the intermediate third portion cross section generally downwardly decreasing in width from the first width adjacent to the first end portion to the second width adjacent to the second end portion.

22. A portable greenhouse of claim 20 wherein each leg has a concave outwardly facing surface.

23. A portable greenhouse of claim 19 wherein the material of the shell is comprised of material that is colored or tinted.

24. A method for controlling ventilation in a portable greenhouse setting, the method comprising the following steps:
providing a light-transmitting shell having an upper substantially enclosed volume and a generally open bottom;
providing a leg or legs supportably coupled to the shell and extending downwardly beyond the open bottom of the shell for engagement with a substrate, the legs able to stably support the shell at variable heights at or above the substrate; and
varying the open space between the substrate and the bottom end of the shell by fully or partially inserting the leg/legs into the substrate.

25. A method for controlling ventilation and lighting in a portable greenhouse setting, the method comprising the following steps:
providing a light-transmitting shell having an upper substantially enclosed volume and a generally open bottom;
providing a leg or legs supportably coupled to the shell and extending downwardly beyond the open bottom of the shell for engagement with a substrate, the legs able to stably support the shell at variable heights at or above the substrate;
providing for selective translucent portions of the shell for diffusing the light within the enclosure;
providing for color or tint in the shell material for selective filtering of light frequencies;
varying the open space between the substrate and the bottom end of the shell by fully or partially inserting the leg/legs into the substrate; and
selecting the translucent portions and color of the material at the time of manufacture for specific environments and plants.
